(19) United States
(12) Patent Application Publication
(10) Pub. No.: US 2010/0097440 A1
(43) Pub. Date: Apr. 22, 2010

(54) COMMUNICATION MODE SWITCHING METHOD AND APPARATUS FOR MOBILE TERMINAL

(75) Inventor: Jung Eun LEE, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/582,920

(22) Filed: Oct. 21, 2009

(30) Foreign Application Priority Data
Oct. 21, 2008 (KR) 10-2008-0102960

(51) Int. Cl. H04N 7/14

(52) U.S. Cl. 348/14.02; 348/E07.077

(57) ABSTRACT

A communication mode switching method and apparatus for a mobile terminal is provided for responding, in voice call mode, to an incoming video call received for a video call rejection period set by the user. A video call establishment method between mobile terminals according to the present invention includes requesting, at a calling mobile terminal, a video call connection to a called mobile terminal; determining, at the called mobile terminal, whether the video call connection satisfies a video call rejection configuration; responding, when the video call connection satisfies the video call rejection configuration, to the calling mobile terminal in voice call mode; and establishing a video call connection in voice call mode between the calling mobile terminal operating in a video call mode and the called mobile terminal operating in voice call mode.

### CLAIM OF PRIORITY

This application claims all benefits of priority from patent application entitled “COMMUNICATION MODE SWITCHING METHOD AND APPARATUS FOR MOBILE TERMINAL” filed in the Korean Intellectual Property Office on Oct. 21, 2008 and assigned Serial No. 10-2008-0102960, the contents of which are incorporated herein by reference in its entirety.

### BACKGROUND OF THE INVENTION

1. Field of the Invention

The present invention relates to mobile communication systems and, in particular, to a communication mode switching method and apparatus for a mobile terminal that is capable of responding, in voice call mode, to an incoming video call received for a video call rejection period set by the user.

2. Description of the Related Art

With the advance of communication technologies, mobile terminals are evolving to become a versatile device supporting various types of communication services. Currently mobile communication technologies are being developed to provide high speed multimedia service integrating voice, video, and data.

Particularly, the video call service is a promising communication service in which the user can talk with a counterpart end user while viewing each other in real time. The video call service is implemented between, or among, terminals that can process the voice input through a microphone and the video data input through a camera and transmit the voice and video data simultaneously. In the voice call service, the video streaming technology is used to transmit and receive voice and video data in real time such the end user can converse while viewing each other. With the deployment of 3^{rd} Generation communication networks, the video call service is becoming a basic communication service.

In the video call mode, the voice signal is output with a high power level compared to that of a voice call mode. This is because the mobile terminal is configured to output the voice signal through a speaker in the video call mode. Since the voice component of the counterpart end user is output through the speaker with a relatively high output power, it is impractical to use the video call service in public places as the conversation with the counterpart end user is exposed to public. Thus, the video call communication is prone to privacy problems as uninvited third parties may be exposed to the received voice component of the video call. In addition, the image of the calling party may be viewed by uninvited third parties.

Typically, the mobile terminal alerts the use of the receipt of a call establishment request with at least one of a ringtone or a vibration and the call is established by the user responding to the call establishment request. That is, the mobile terminal is configured to enter the video call mode when an incoming video call is detected, and enter the voice call mode when an incoming voice call is received.

The communication mode of the mobile terminal of the called party is determined according to the type of the incoming call made by the calling party.

When a video call establishment request is received, currently the called party mobile terminal must use the video call service to communicate with the calling party mobile terminal even when the called party does not want to use the video call service. Once the called party decides to receive the incoming video call, the mobile terminal of the called party captures the image input by means of the camera, which is activated in response to the incoming video call, and transmits the image to the mobile terminal of the calling party regardless of called party's intention to accept the video call. To prevent an image, e.g. user's facial image, from being transmitted, the called party must cover the camera lens or set a default image for responding to the video call; thereby causing inconvenience to the user.

Also, the mobile terminal supporting video call operations or functions activates its speakerphone functions when the video call connection is established such that the voice of the calling party is broadcast by means of a speaker within the mobile terminal of the calling party. The transmitted voice signal along with the ambient noisy sounds surrounding the calling party are transmitted to the called party. In response to the video call request, the mobile terminal of the called party mobile terminal, similarly activates its speakerphone operation and the voice of the called party and surrounding ambient sounds are transmitted to the mobile terminal of the calling party.

Accordingly, when the called party end user is in a situation where it is not wanted to transmit the video data (e.g. when the user does not want to expose his/her current look or current place) to a calling party or wants just the voice conversation, the called party must take additional actions to deactivate the speakerphone function or switch the communication mode to receiver mode with one or more key manipulations.

However, with only a voice call response to a video call request, it may be considered by the calling party that the video call has failed to connect. In this case, the calling party is likely to make the video call repeatedly in order to establish a video call. This results unhappiness to both the called party and the calling party as former desires a voice call while the latter desires a video call.

Current conventional mobile terminals supporting video call lack a mechanism to receive an incoming video call without exposing personal privacy information in a situation where the video communication is uncomfortable or embarrassing, except for giving up receiving the video call.

Accordingly, there is a need to develop a method and apparatus for allowing the user to receive an incoming video call without exposing private situation unintentionally and without making the caller feel uncomfortable.

### SUMMARY OF THE INVENTION

The present invention provides a communication mode switching method and apparatus for a mobile terminal that is capable of receiving an incoming video call in voice call mode according to a video call rejection configuration set by the user.

Also, the present invention provides a communication mode switching method and apparatus for a mobile terminal supporting voice call that is capable of switching a video call mode to a voice call mode.

Also, the present invention provides a communication mode switching method and apparatus for a mobile terminal that is capable of rejecting an incoming video call and responding to the video call in a voice call mode in which no video data is transmitted to the calling mobile terminal.

Also, the present invention provides a communication mode switching method and apparatus for a mobile terminal that is capable of determining the communication mode of the mobile terminal according to whether an incoming video call satisfies conditions of a video call rejection configuration stored in the mobile terminal or registered with a network.

In accordance with an exemplary embodiment of the present invention, a video call establishment method between mobile terminals includes requesting, at a calling mobile terminal, a video call connection to a called mobile terminal; determining, at the called mobile terminal, whether the video call connection satisfies a video call rejection configuration; responding, when the video call connection satisfies the video call rejection configuration, to the calling mobile terminal in a voice call mode; and establishing a video call connection in voice call mode between the calling mobile terminal operating in the video call mode and the called mobile terminal operating in the voice call mode.

In accordance with another exemplary embodiment of the present invention, a video call establishment method between mobile terminals includes requesting, at a calling mobile terminal, a video call connection to a called mobile terminal via a mobile communication network; determining, at the mobile communication network, whether the video call connection satisfies a video call rejection configuration of the called mobile terminal; sending, when the video call connection satisfies the video call rejection configuration, the calling mobile terminal and the called mobile terminal a notification message informing the calling mobile terminal and the called terminal that a video call connection is initiated and available in voice call mode; and establishing a video call connection in voice call mode between the calling mobile terminal and the called mobile terminal.

In accordance with another exemplary embodiment of the present invention, a communication mode control method for a mobile terminal includes determining, when a video call connection is requested by a calling mobile terminal, whether information regarding the video call is requested satisfies conditions of a video call rejection configuration of a called mobile terminal; configuring, when the information satisfies the conditions of the video call rejection configuration, the called mobile terminal into a voice call mode; transmitting a communication mode switching notification message to the calling mobile terminal; establishing, when a voice call mode response message is received from the calling mobile terminal, a video call connection in voice call mode with the calling mobile terminal operating in voice call mode; and establishing, when a video call mode response message is received from the calling mobile terminal, a video call connection in voice call mode with the calling mobile terminal operating in video call mode.

In accordance with another exemplary embodiment of the present invention, a communication mode control method for a mobile terminal includes transmitting, at a calling mobile terminal, a video call connection request message to a called mobile terminal; receiving a response message in response to the video call connection request message; checking, when the response message is a video call rejection message, a communication mode of the calling mobile terminal; establishing, when the communication mode of the calling mobile terminal is a video call mode, a video call connection in video call mode; switching, when the communication mode of the calling mobile terminal is a voice call mode, the video call mode to the voice call mode; and establishing a video call connection in voice call mode with the called mobile terminal operating in voice call mode.

In accordance with still another exemplary embodiment of the present invention, a mobile terminal includes a camera unit which captures visual image input through a lens and converts the visual image into video data in a video call mode; a display unit which displays images captured by the camera unit and received from a counterpart terminal simultaneously in the video call mode; a storage unit which stores a video call rejection configuration; and a control unit which controls a video call connection in voice call mode over a 3^{rd} Generation (3G) network without switching to a 2G network. The control unit including a processor for receiving information regarding a status of the counterpart terminal and establishing a configuration based on the status of the counterpart terminal.

In accordance with another exemplary embodiment of the present invention, a mobile terminal includes a processor in communication with a memory, the memory storing code which when accessed by the processor causes the processor to: transmit a request message to establish a video call mode; receive a notification message in response to the request message; switching to a voice call mode in response to the notification message, wherein at least audio data is transmitted.

### BRIEF DESCRIPTION OF THE DRAWINGS

The above and other objects, features and advantages of the present invention will be more apparent from the following detailed description in conjunction with the accompanying drawings, in which:

FIG. 1 is a schematic diagram illustrating a mobile communication system;

FIG. 2 is a sequence diagram illustrating operations of mobile terminals and network for a communication mode switching according to an exemplary embodiment of the present invention;

FIG. 3 is a sequence diagram illustrating operations of mobile terminals and network for a communication mode switching method according to another exemplary embodiment of the present invention;

FIG. 4 is a flowchart illustrating a communication mode switching method for a called mobile terminal according to an exemplary embodiment of the present invention;

FIG. 5 is a flowchart illustrating a communication mode switching method for a calling mobile terminal according to an exemplary embodiment of the present invention; and

FIG. 6 is a block diagram illustrating a configuration of a mobile terminal according to an exemplary embodiment of the present invention.

### DETAILED DESCRIPTION

Exemplary embodiments of the present invention are described in zo detail with reference to the accompanying drawings. The same reference numbers are used throughout the drawings to refer to the same or like parts. Detailed descriptions of well-known functions and structures incorporated herein may be omitted to avoid obscuring the subject matter of the present invention.

In the following description, a communication mode switching method and system is proposed. According to exemplary embodiments of the present invention, the communication mode is switched between the video call mode and the voice call mode according to the conditions set by a user. Particularly in an exemplary embodiment of the present invention, the called mobile terminal or the network can determine the communication mode of the called mobile terminal according to whether the incoming video call satisfies conditions of a video call rejection configuration of the called mobile terminal.

In an exemplary embodiment of the present invention, when a video call establishment is requested by a calling mobile terminal, the called mobile terminal or the network determines the communication mode of the called mobile terminal as being voice call mode, when t conditions of a video call rejection configuration are satisfied, and transmits a communication mode switching announcement message to the calling mobile terminal, thereby establishing a voice call connection between the called mobile terminal and the calling mobile terminal.

In an exemplary embodiment of the present invention, a communication mode switching function is proposed for switching a video call requested by a calling mobile terminal to a voice call. In order to implement the communication mode switching function, the user can set conditions for rejecting incoming video calls. In an exemplary embodiment of the present invention, the user sets the video call rejection configuration such that the called mobile terminal rejects the video call and establishes a video call session in voice call mode with the calling mobile terminal. In an exemplary embodiment of the present invention, the user registers the video call rejection configuration with the network such that the network rejects the video call and establishes a voice call connection between the calling mobile terminal and the called mobile terminal.

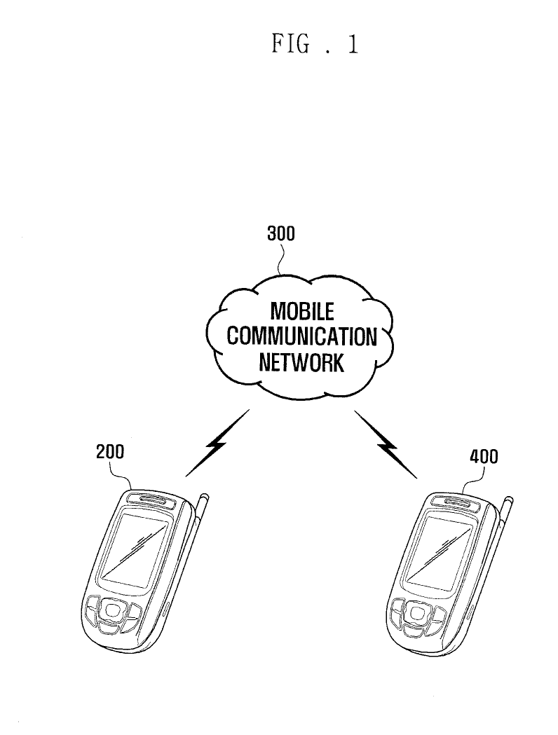

FIG. 1 is a schematic diagram illustrating a mobile communication system to which a communication mode switching method according to an exemplary embodiment of the present invention is applied.

Referring to FIG. 1, the mobile communication system includes a mobile communication network 300 and a plurality of mobile terminals 200 and 400. The mobile communication network 300 provides the mobile terminals 200 and 400 with voice, video, and data communication service. The first and second mobile terminals 200 and 400 access the mobile communication network 300 via radio channels and are serviced by the mobile communication network 300. The mobile terminals 200 and 400 support the communication mode switching function according to an exemplary embodiment of the present invention such that each of the mobile terminal 200 and 400 can switch its communication mode between a video call mode and a voice call mode.

In an exemplary embodiment of the present invention, the called mobile terminal receives and stores a video call establishment request message and sends a communication mode switching request message to the calling mobile terminal via the mobile communication network 300. If the calling mobile terminal that transmitted the video call establishment request message accepts the communication mode switching request, a voice call connection is established between the calling mobile terminal and the called mobile terminal.

In an exemplary embodiment of the present invention, the called mobile terminal accepts a video call establishment to activate the video call mode and then switches the video call mode to the voice call mode and sends a communication mode switching notification message to the calling mobile terminal. In this case, the called mobile terminal processes the video packets transmitted by the calling mobile terminal in a background mode while processing the voice packets in a foreground mode. That is, the mobile terminals 200 and 400 can establish a video call session in a voice call mode via a 3G network without switching to a 2G network for voice communication.

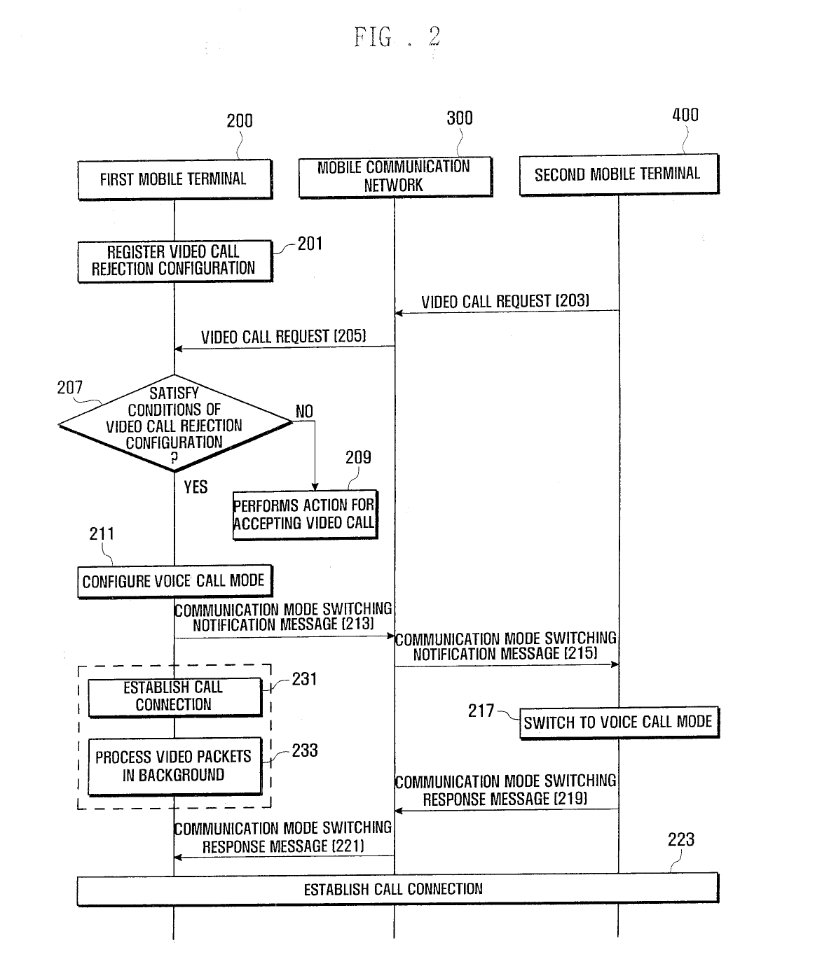

FIG. 2 is a sequence diagram illustrating operations of mobile terminals and network shown in FIG. 1 for a communication mode switching according to an exemplary embodiment of the present invention.

In an exemplary embodiment depicted in FIG. 2, the called mobile terminal stores a video communication rejection configuration set by the user. As would be appreciated, reference is made to the called mobile terminal as storing a rejection configuration, however, each of the terminals in the network may at some time be a “called” terminal and thus storage of rejection criteria may be individually established for each of the mobile terminals that may access the network 300.

FIG. 2 is depicted under the assumption that the second mobile terminal 400 of FIG. 1 is a calling mobile terminal which transmits a video call establishment request message and the first mobile terminal 200 of FIG. 1 is a called mobile terminal which receives the video call establishment request message.

Referring to FIG. 2, the first mobile terminal 200 registers a video call reject configuration in response to a user request and stores the registered video call reject configuration (201).

The video call reject configuration includes at least information defining the time period for which incoming video calls may be rejected and composed of an enable/disable status and rejection time (date/time/expiry). The user can set the video call rejection configuration on a video call rejection configuration interface (User Interface, UI).

For instance, the user can activate the video call rejection function; by setting the rejection date item with one of the options such as customized, once, everyday, Monday to Friday, a specific day; or by setting the rejection time item with a start and an end time of the video call rejection, or by setting a rejection duration for maintaining the settings, using the video call rejection configuration interface. Table 1 shows an exemplary video call rejection configuration.

TABLE 1

| Item | Setting |
|---|---|
| Status | Active |
| Date | Monday through Friday |
| Time | Start: 09:00 AM/End: 06:00 PM |
| Duration | 2008. 10. 01 |

In the exemplary video call rejection configuration of table 1, the video call rejection configuration is set to reject the incoming video call between 09:00 AM to 06:00 PM from Monday to Friday and expire on Oct. 1, 2008, wherein the expiration date is a future date

According to the video call rejection function is deactivated on Saturday and Sunday and reactivated on Monday. In more detail, the video call rejection function is activated at 09:00 AM and deactivated at 06:00 PM every day except for Saturday and Sunday, and this configuration expires on Oct. 1, 2008 automatically. From Oct. 1, 2008, the video call rejection function is not activated until the user resets the video call rejection configuration.

In this manner, the first mobile terminal 200 registers the video call rejection configuration set by the user. (201)

Although not shown, it would be understood that a default configuration mode may also be established by the user with a single key depression. For example, a default configuration mode may be set between 9 am to 5 pm Monday through Friday, to expire one week from a present date. Alternatively, the default configuration mode may be set with a single key depression to represent a known time period into the future, for the current day and to expire today. That is, the user may depress a single key to disallow video calls for a known period of time from the time of depressing the single key on this current date. This may be useful when a user is entering an area for a known period of time. As would be appreciated, the user may be allowed to set the default values.

Thereafter, the second mobile terminal 400 sends a video call establishment request message destined to the first mobile terminal 200 (203). If the user of the second mobile terminal 400 makes a video call to the first mobile terminal 200, the video call establishment request message is transmitted to the mobile communication network 300. Upon receipt of the video call establishment request message, the network 300 forwards the video call establishment request message to the first mobile terminal (205). That is, the mobile communication network 300 checks the destination terminal ID of the video call establishment request message and transmits the video call establishment request message to the destination terminal, i.e. the first mobile terminal 200.

Upon receipt of the video call establishment request message, the first mobile terminal 200 checks the video call rejection configuration set by the user and determines whether the video call establishment request message satisfies the conditions of the video call rejection configuration (207).

Although not shown, when the video call establishment request message is received, the first mobile terminal 200 can output an alert to notify user of the receipt of a video call establishment request message.

The alert can be output in the form of a vibration followed by displaying a predetermined notification message on the screen. The alert can be an event only for informing of the receipt of the video call establishment request message but not alerting the user of the type of the incoming call. In this case, the first mobile terminal 200 does not take the actions related to the video call mode such as ringtone output, camera activation, display activation, vibration output. Also, the alert can be skipped according to the configuration of the first mobile terminal 200.

If the video call establishment request message does not satisfies the conditions of the video call rejection configuration at step 207, the first mobile terminal 200 performs an action for accepting the video call establishment request message (209). In this case, the first mobile terminal 200 can output a ringtone and activate the camera and display units for video call session. Since the video call session establishment procedure is out of the scope of the present invention, detailed description about the video call session establishment procedure is not disclosed in detail herein.

Otherwise, if the video call establishment request message satisfies the conditions of the video call rejection configuration at step 207, the first mobile terminal 200 establishes a video call session in a voice call mode (211). In an exemplary embodiment of the present invention, the voice call mode is a communication mode in which the mobile terminal transmits the voice signal input through a microphone while switching off the display unit, camera unit, and the speakerphone function even when an incoming video call is received.

After configuring the voice call mode (211), the first mobile terminal 200 transmits a communication mode switching notification message destined to the calling mobile terminal 400 (213). The communication mode switching notification message is a message to inform the calling mobile terminal that the called mobile terminal is configured to operate in voice call mode. That is, when an incoming video call is detected at a time satisfying the conditions of the video call rejection configuration, the first mobile terminal 200 transmits the communication mode switching notification message to the second mobile terminal 400 rather than accepting the video call establishment requested by the calling terminal 400. In an exemplary embodiment of the present invention, the first mobile terminal 200 can be configured to reject the video call establishment request message transmitted by the second mobile terminal 400 and transmit a voice call establishment request message destined to the second mobile terminal 400.

The communication mode switching notification message is received at the mobile communication network 300.

Upon receipt of the communication mode switching notification message, the mobile communication network 300 identifies the recipient terminal (i.e. the second mobile terminal 400) to which the communication mode switching notification message is destined by referencing the destination identity field of the communication mode switching notification message and forwards the communication mode switching notification message to the second mobile terminal 400 (215).

Upon receipt of the communication mode switching notification message forwarded by the mobile communication network 300, the second mobile terminal 400 displays an announcement message informing the user of the second mobile terminal that the first mobile terminal is configured to operated in voice call mode and switches its communication mode from the video call mode to the voice call mode (217). Next, the second mobile terminal 400 transmits a communication mode switching response message destined to the first mobile terminal 200 (219). The communication mode switching response message is received by the mobile communication network 300. Upon receipt of the communication mode switching response message, the mobile communication network 300 forwards the communication mode switching response message to the first mobile terminal 200 (221).

Although not shown, at step 217, with the switch of a voice call mode, the second mobile terminal 400 can take actions to switch off its camera, display, and speakerphone, which are required in the video call mode. In an exemplary embodiment of the present invention, the second mobile terminal can be configured to switch off the video call mode and make a voice call to the first mobile terminal 200 in response to the communication mode switching notification message.

Once the communication mode switching response message is received, the first and second mobile terminals 200 and 400 establish a voice call connection via the mobile communication network (223). Here, the voice call connection can be a video call session established over a 3G network for exchanging voice packets between the first and second mobile terminals 200 and 400. This means that the first and second mobile terminals 200 and 400 communicate through a 3G video communication channel in voice call mode.

In this manner, the communication mode switching method according to an exemplary embodiment of the present invention allows the end users of the first and second mobile terminals 200 and 400 to negotiate the communication mode and switching the communication mode between the video call mode and the voice call mode before establishing a call session or in the middle of the call session.

In an exemplary embodiment of the present invention, the first mobile terminal 200 can be configured to operate in the voice call mode in response to the video call establishment message (231) and processes the video packets in background (233) after transmitting the communication mode switching notification message at step 213. That is, the first mobile terminal 200 can establish a video call session in voice call mode for voice communication with the second mobile terminal 400 via the mobile communication network 300 even though the second mobile terminal 400 requests the video call session in video call mode. In this case, the first mobile terminal 200 processes the voice and video packets transmitted by the second mobile terminal 400 but outputs only the voice data carried by the voice packets through the speaker as if operating in normal voice call mode.

In the background processing, the video packets received from the second mobile terminal 400 are processed and transferred to the display unit of the first mobile terminal 200 but not displayed since the display unit is switched off. Also, the first mobile terminal 200 can be configured to discard the incoming video packets so as not to be transferred to the display unit. In the mean time, the second mobile terminal 400 switches its communication mode from the video call mode to the voice call mode upon receipt of the communication mode switching notification message and then processes the call establishment procedure in the voice call mode or processes the call establishment procedure while maintaining the video call mode.

In case that the call establishment procedure progresses in the video call mode, the second mobile terminal 400 can display an announcement message informing the user of the communication mode switch to the voice call mode according to the receipt of the communication mode switching notification message transmitted by the first mobile terminal 200 and/or display a preset default image. In case that the call establishment procedure progresses in voice call mode, the second mobile terminal 400 can operate in the speakerphone mode as in a normal video call mode. Thus, while the second terminal may be transmitting messages in a voice call mode its operation may be that of a video call mode wherein the display and speakerphone operations may be active.

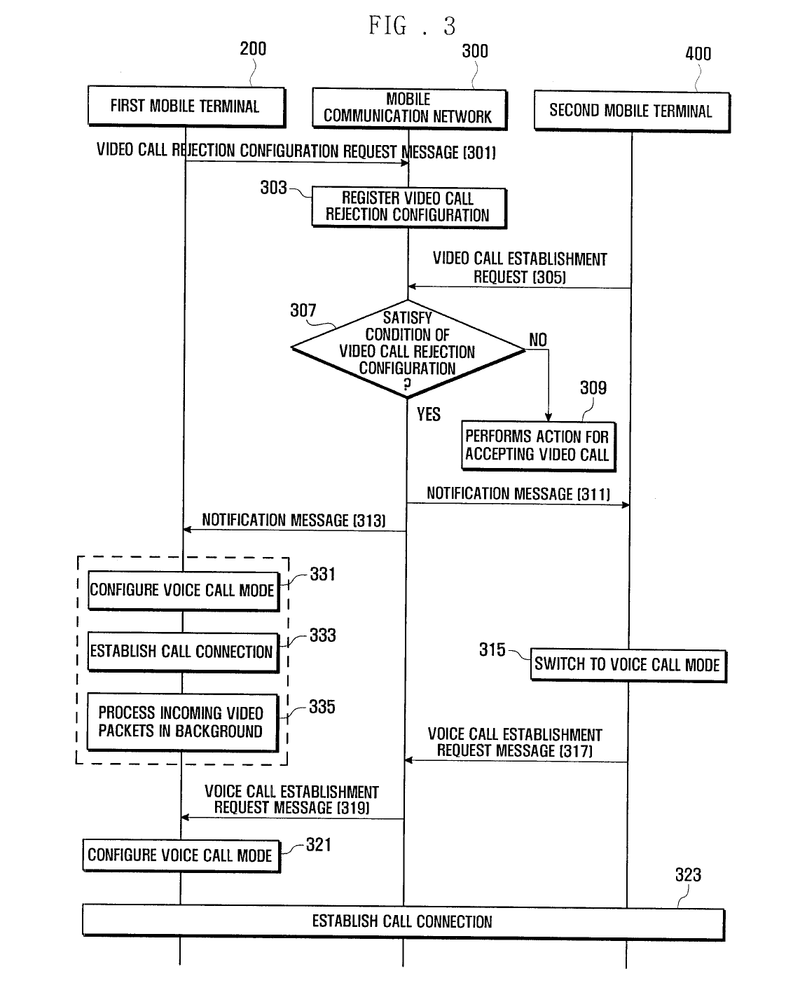

FIG. 3 is a sequence diagram illustrating operations of mobile terminals 200, 400 and network 300 for a communication mode switching method according to another exemplary embodiment of the present invention.

FIG. 3 is depicted under the assumption that the second mobile terminal 400 of FIG. 1 is a calling mobile terminal which transmits a video call establishment request message and the first mobile terminal 200 of FIG. 1 is a called mobile terminal which receives the video call establishment request message.

In the exemplary embodiment depicted in FIG. 3, the first mobile terminal 200 registers the video communication rejection configuration with the mobile communication network 300.

The first mobile terminal 200 transmits a video call rejection configuration request message to the mobile communication network 300 (301). Upon receipt of the video call rejection configuration request message, the mobile communication network 300 registers a video call rejection configuration carried by the video call rejection configuration request message (303).

The video call rejection configuration is set on a user configuration interface by the user with the information as described with reference to table 1 and then transmitted to the mobile communication network 300 by using the video call rejection configuration request message. The video call rejection configuration request message also contains the terminal information including a terminal identifier and/or a phone number assigned to the first mobile terminal 200.

In one aspect of the exemplary embodiment of the present invention, the video call rejection configuration can be registered in such a manner that the user of the first mobile terminal 200 accesses a video call rejection configuration website provided by the mobile communication network 300 and requests the video call rejection configuration by inputting the video call rejection information. In response to the user request, the mobile communication network 300 registers the video call rejection configuration along with the device information.

After the video call rejection configuration of the first mobile terminal 200 is registered with the mobile communication network 300, the second mobile terminal 400 sends a video call establishment request message to the mobile communication network 300 (305). That is, the user of the second mobile terminal 400 makes a video call to the first mobile terminal 200. When the video call establishment request message is received, the mobile communication network 300 checks the destination terminal (i.e. the first mobile terminal 200) by referencing the destination terminal ID field of the video call establishment request message and determines whether the video call establishment request message satisfies the conditions of the video call rejection configuration registered by the first mobile terminal 200 (307).

If the video call establishment request message does not satisfy the conditions of the video call rejection configuration of the first mobile terminal 200, the mobile communication network 300 handles the video call establishment request message in a normal video call handling process (309). Since the normal video call handling process is out of the scope of the present invention, detailed description on the normal video call handling process is omitted.

Otherwise, if the video call establishment request message satisfies the conditions of the video call rejection configuration of the first mobile terminal 200, the mobile communication network 300 transmits a voice call solicitation message to the second mobile terminal 400 in order to notify the second mobile terminal 400 that the first mobile terminal 200 is configured to operate in a video call-restricted state and solicit the second mobile terminal 400 to switch the video call mode to the voice call mode (311). At the same time, the mobile communication network 300 transmits a notification message to the first mobile terminal 400 in order to notify the first mobile terminal 400 that a video call establishment is requested by the second mobile terminal 400 (313). The notification message transmitted to the first mobile terminal 200 can include the information indicating the transmission of the voice call solicitation message to the second mobile terminal 400.

When the voice call solicitation message is received, the second mobile terminal switches its communication mode to the voice call mode (315) and transmits a voice call establishment request message to the mobile communication network 300 (317). Upon receipt of the voice call establishment request message, the mobile communication network 300 forwards the voice call establishment request message to the first mobile terminal 200 (319).

The second mobile terminal 400 can be configured to display an announcement message on its display unit to inform a user that a voice call establishment process is progressing. The communication mode switching of the second mobile terminal 400 is performed by switching off the video call mode (i.e. switching off the camera, display and speakerphone functions) and switching on the voice call mode. In an exemplary embodiment of the present invention, the second mobile terminal 400 can be configured to terminate the ongoing video call establishment process and initiate a voice call establishment process. Alternatively, the second mobile terminal may operate in a voice call mode for transmission of signals and in video call mode in receipt of signals, wherein the display may provide a preset image and the speakerphone unit may allow vocal input and output.

If the voice call establishment request message is received, the first mobile terminal 200 is configured to operate in the voice call mode (321). In an exemplary embodiment of the present invention, the voice call mode is a communication mode in which some actions related to the video call mode are disabled even though an incoming video call is detected, e.g. switching off the speakerphone mode and blocking incoming and output video stream processes.

Once the first mobile terminal 200 is configured to operate in the voice call mode, a communication channel is established between the first and second mobile terminals 200 and 400 on the video communication channel (3G network (323).

This means that the first and second mobile terminals 200 and 400 establish a video call session in voice call mode over a 3G video communication channel. In this manner, the communication mode switching method according to an exemplary embodiment of the present invention allows the end users of the first and second mobile terminals 200 and 400 to negotiate the communication mode and switching the communication mode between the video call mode and the voice call mode before establishing a call session or in the middle of the call session.

In an exemplary embodiment of the present invention, the first mode mobile terminal 200 can switch its communication mode to the voice call mode upon receipt of the announcement message (331) and establishes a video call session in voice call mode on a video communication channel in response to the video call establishment request message transmitted by the second mobile terminal 400 (333).

That is, the first mobile terminal 200 can process the video call establishment with the second mobile terminal 400 in voice call mode via the mobile communication network 300. If the video call session is established in voice call mode, the first mobile terminal 200 processes the incoming video packets transmitted by the second mobile terminal 400 in background and processes the incoming voice packets in foreground as in the normal voice call mode (335). While the incoming video packets are processed in background, the video data carried by the video packets are supplied to the display unit but not displayed since the display unit is switched off. Also, the incoming video packets can be discarded rather than be transferred to the switched-off display unit. In addition, the second mobile terminal 400 can switch its communication mode from the video call mode to the voice call mode to process the call establishment procedure in voice call mode in response to the voice call solicit message or process the call establishment procedure while maintaining the video call mode according to the configuration settings.

In case that the call establishment procedure progresses in the video call mode, the second mobile terminal 400 can display an announcement message informing a user that the first mobile terminal is configured to operate in voice call mode according to the receipt of the voice call solicit message transmitted by the mobile communication network 300 and/or display a preset default image. In case that the call establishment procedure progresses in voice call mode, the second mobile terminal 400 can operate in the speakerphone mode as in the normal video call mode.

The communication mode switching methods and structure and functions of the mobile terminal to accomplish the communication mode switching methods are described hereinafter. However, it is noted that the present invent is not limited to the following embodiments but other embodiments can be envisioned.

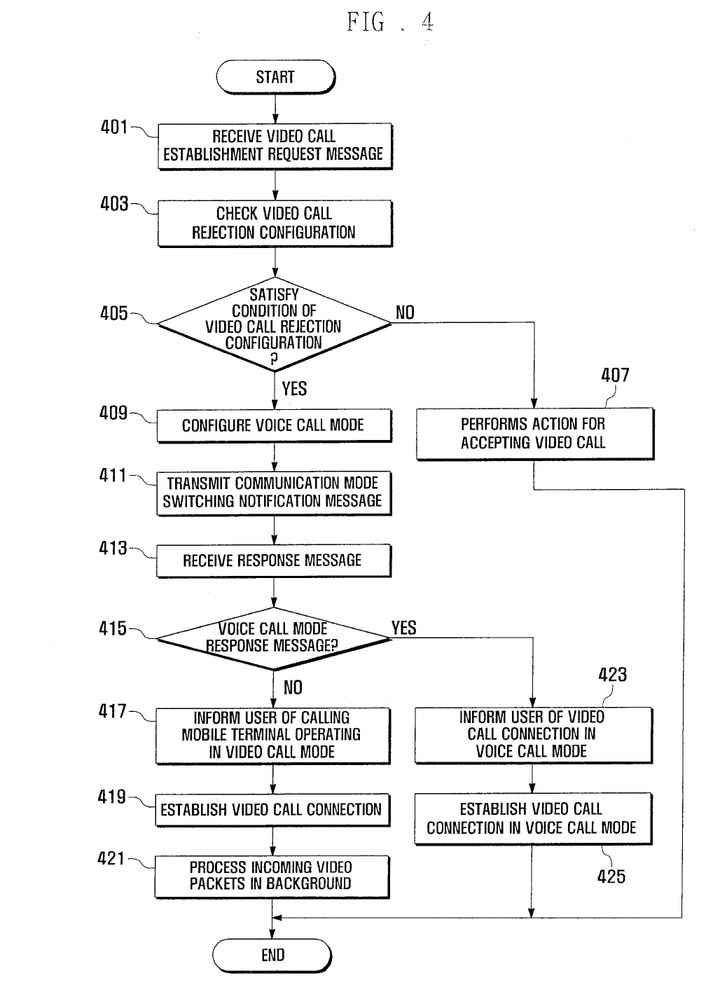

FIG. 4 is a flowchart illustrating a communication mode switching method for a called mobile terminal according to an exemplary embodiment of the present invention. In the exemplary embodiment depicted in FIG. 4, the video call rejection configuration is registered in a called mobile terminal to reject the incoming video call satisfying the conditions of the call rejection configuration.

Referring to FIG. 4, the called mobile terminal receives a video call establishment request message (401). The mobile terminal next checks the video call rejection configuration that had been set by the user (403) and determines whether the video call establishment request message satisfies the conditions of the video call rejection configuration (405).

If the video call establishment request message does not satisfy the conditions of the video call rejection configuration, the mobile terminal accepts the video call establishment request and performs the action for establishing a video call connection with the calling mobile terminal (407). Since the video call establishment procedure is well-known in the art, detailed description of the video call establishment procedure is not presented herein.

Returning to step 405, if the video call establishment request message satisfies the conditions of the video call rejection configuration, the mobile terminal switches on the voice call mode (409). Here, the voice call mode is a communication mode in which the mobile terminal operates as in the normal voice call mode even though a video call establishment request message is received.

After switching on the voice call mode, the mobile terminal transmits a communication mode switching notification message to the calling mobile terminal (411). Next, the mobile terminal receives a communication mode switching response message from the calling mobile terminal in response to the communication mode switching notification message (413) and determines whether the communication mode switching response message is a voice call mode response message or a video call mode response message (415).

If the communication mode switching response message is a voice call mode response message, the mobile terminal informs the user of the initiation of the video call session in the voice call mode (423) and establish a video call session with the calling mobile terminal (425). At this time, the calling mobile terminal switches its communication mode to the voice call mode and establishes the video call session with the called mobile terminal in the voice call mode.

When the video call session is established in the voice call mode, the calling mobile terminal can be configured to transmit the voice packets but not video packets. That is, the calling mobile terminal, which has switched from the video call mode to the voice call mode, need not generate video packets to be transmitted to the called mobile terminal. In FIG. 4, the called mobile terminal can establish the video call session in voice call mode by skipping step 423.

Returning to step 415, if the communication mode switching response message is a video call mode response message, the mobile terminal informs the user that the calling mobile terminal is operating in video call mode (417) and establishes the video call session in voice call mode while ignoring the video call mode of the called mobile terminal (419). In case that the video call session has been established in voice call mode, the called mobile terminal processes the incoming video packet transmitted by the calling mobile terminal in a background mode (421).

In the background mode, the called mobile terminal does not display the video data carried by the incoming video packets on the display unit. At step 419, the called mobile terminal establishes the video call session by accepting the video call establishment request of the calling mobile terminal. In this case, the incoming data stream includes both the video and voice packets. This means the calling mobile terminal processes the video signal input through its camera and voice signal input through its microphone (e.g., speakerphone) and transmits the video and voice signals through the video communication channel since it operates in the video call mode. In the meantime, the called mobile terminal operating in voice call mode processes the incoming video packets in background mode and outputs only the voice data carried by the video packets. In FIG. 4, the called mobile terminal can also establish the video call session in voice call mode with skipping step 417.

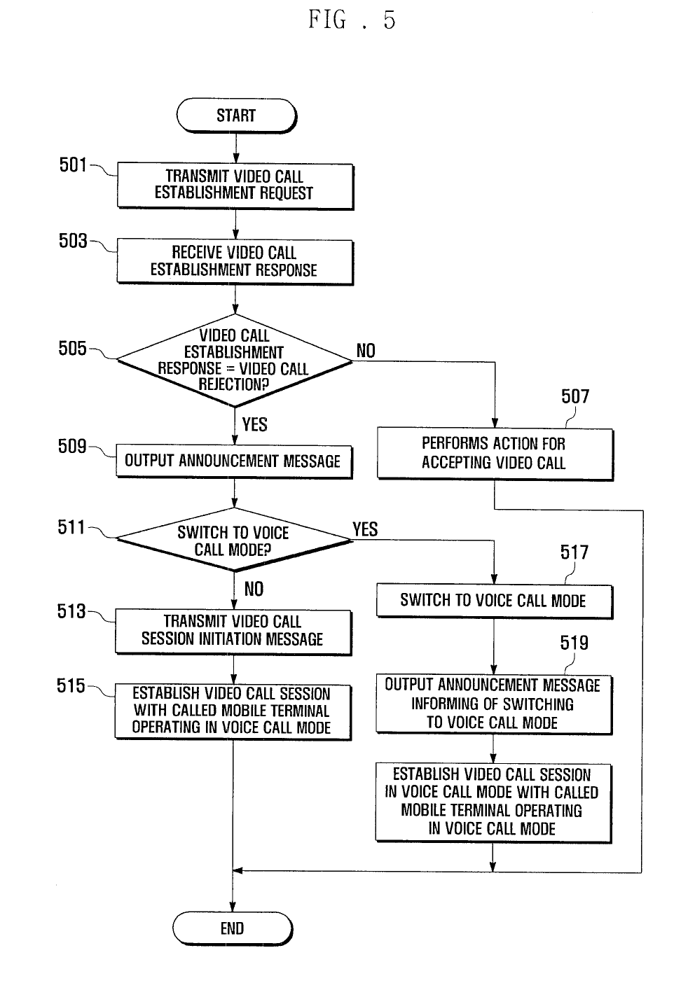

FIG. 5 is a flowchart illustrating a communication mode switching method for a calling mobile terminal according to an exemplary embodiment of the present invention. In the exemplary embodiment depicted in FIG. 5, the video call rejection configuration is registered in a called mobile terminal to reject the incoming video call satisfying the conditions of the call rejection configuration.

Referring to FIG. 5, the calling mobile terminal first transmits a video call establishment request message (501) and receives a response message in response to the video call establishment request message (503).

Upon receipt of the response message, the calling mobile terminal determines whether the response message is a video call rejection message (505).

If the response message is not the video call rejection message, the calling mobile terminal progresses the video call establishment procedure (507). That is, the response message is video call accept message, the calling mobile terminal processes the video call establishment procedure. Since the video call establishment procedure is well known in the art, detailed description about the video call establishment procedure is not presented herein.

Otherwise, if the response message is the video call rejection message (step 505), the calling mobile terminal outputs an announcement message informing the user of the receipt of the video call rejection message (509). The announcement message can be a message informing that the called mobile terminal initiates a voice call connection procedure other than video call connection procedure.

In an exemplary embodiment of the present invention, the calling mobile terminal can be configured to output a popup message asking whether the user wants to proceed in a video call establishment procedure or switch to a the video call mode to a voice call mode procedure in response to the video call rejection message. After outputting the popup message, the calling mobile terminal determines whether to switch the video call mode to the voice call mode (511).

If it is determined not to switch the video call mode to the voice call mode, the calling mobile terminal transmits a video call session initiation message to the called mobile terminal (513). As a consequence, the calling mobile terminal, operating in video call mode, establishes a video call session with the called mobile terminal operating in voice call mode (515). At this time, the calling mobile terminal can output an announcement message, informing the calling user that the called mobile terminal is operating in voice call mode, or outputting a preset default image on a called party displayed a called user image in the display unit of the calling mobile terminal.

Otherwise, if it is determined to switch the operation of the calling terminal from the video call mode to the voice call mode at step 511, the calling mobile terminal switches the video call mode to the voice call mode (517) and outputs an announcement message informing the user that a video call session is established with the called mobile terminal in voice call mode (519). As a consequence, the calling mobile terminal, operating in voice call mode, establishes a video call session, voice call mode with the called mobile terminal operating in voice call mode (521).

Once the video call mode is switched to the voice call mode, the calling mobile terminal processes the voice signal input through the microphone (e.g., speakerphone) but not the video signal input through the camera such that only the voice packets are transmitted to the called mobile terminal through the video communication channel. In case that the communication mode is switched to the voice call mode, the calling mobile terminal can also establish the video call session by skipping step 519.

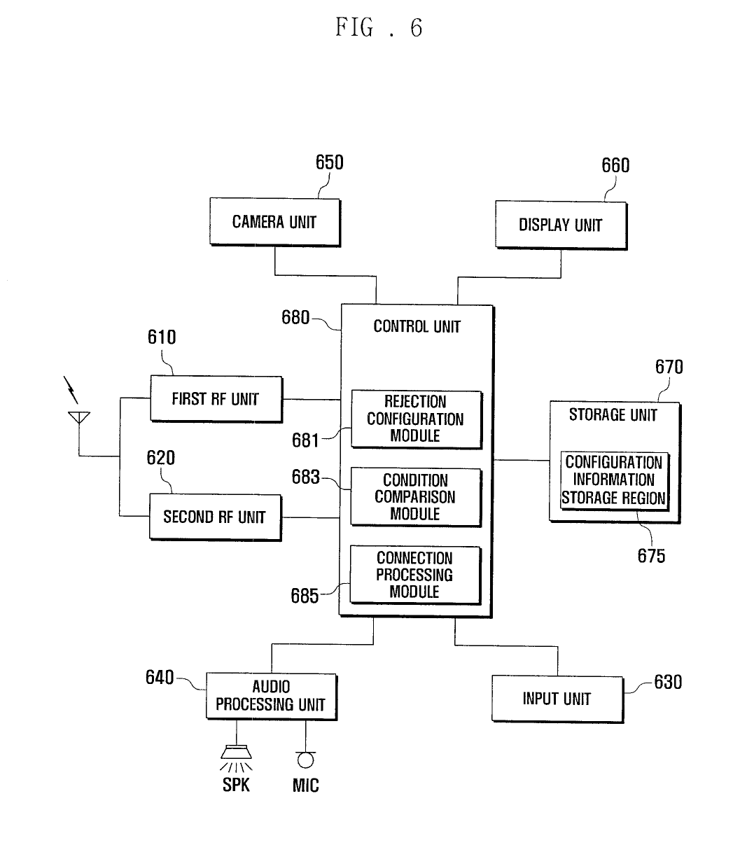

FIG. 6 is a block diagram illustrating a configuration of a mobile terminal according to an exemplary embodiment of the present invention. The configuration of the mobile terminal depicted in FIG. 6 can be applied to the called mobile terminal and the calling mobile terminal.

Referring to FIG. 6, the mobile terminal includes a first Radio Frequency (RF) unit 610, a second RF unit 620, an input unit 630, an audio processing unit 640, a camera unit 650, a display unit 660, a storage unit 670, and a control unit 680. The storage unit 670 includes a configuration storage region 675, and the control unit 680 includes a rejection configuration module 681, a condition comparison module 683, and a connection processing module 685.

The first and second RF units 610 and 620 are responsible for radio communication of the mobile terminal. Each of the first and second RF units 610 and 620 allows the mobile terminal to establish a radio link with a corresponding mobile communication network for voice, video, and data communications. Each of the first and second RF units 610 and 620 includes an RF transmitter for up-converting and amplifying the transmission signal frequency and an RF receiver for low noise amplifying and down-converting the received signal.

Particularly in an exemplary embodiment of the present invention, one of the first and second RF units 610 and 620 supports 3 G communications, which allows the mobile terminal to access the 3G mobile communication network for the voice, video, and data communications, and the other RF unit allows the mobile terminal to access the 2G mobile communication network for voice and data communications. 3G and 2 G communications protocols are well known in the art and need not be described herein.

The input unit 630 is configured to generate signals corresponding to the keystrokes entered on the alphanumeric and functions keys and transfers the signals to the control unit 680. Particularly in an exemplary embodiment of the present invention, the input unit 630 is configured to receive the video call rejection configuration input by the user and transfer the video cal rejection configuration to the control unit 680.

The audio processing unit 640 is coupled to a microphone (MIC) and a speaker (SPK) and processes the voice signal input through the microphone to output the voice sing to the control unit 680 in the form of voice data and processes the voice data input from the control unit 680 through the speaker in the form of an audible sound wave. That is, the audio processing unit 640 converts the analog audio signal input through the microphone (MIC) into the digital audio signal and outputs the digital audio signal to the control unit 680, and converts the digital audio signal input through the control unit 680 into the analog audio signal and outputs the converted analog audio signal through the speaker (SPK). As would be appreciated, the microphone and speaker assembly may be included into a single device, such as a speakerphone or a headset. The headset may be physically connected to the control unit 680 by a wired connection or may be wirelessly connected through one or more wireless communication protocols (e.g., Bluetooth).

The camera unit 650 converts the light (optical signal) input through a camera lens into digital video data by means of a camera sensor. The camera unit 650 can include a camera sensor for converting the optical signal into an electrical signal and a signal processor for converting the electrical signal into digital data. The camera sensor and signal processor can be implemented as an integrated device or as separated devices.

Particularly in an exemplary embodiment of the present invention, the camera unit 650 can be configured to take visual image such as user's face and supplies the visual image to the display unit 660 and the control unit 680 in the video call mode. The camera unit 650 can be configured to switch on in the video call mode and switch off in the voice call mode under the control of the control unit 680. That is, the camera unit is configured to switch on or off depending on the communication mode of the mobile terminal. As would be recognized, the camera unit may periodically take individual pictures to be transmitted over the 3G network as video stream images, or may take continuous pictures (i.e, video stream) to be transmitted over the 3G network.

The display unit 660 displays execution screens corresponding to the applications running in the mobile terminal, operation status of the functions activated in the mobile terminal, and user data input through the input unit 630. Particularly in an exemplary embodiment of the present invention, the display unit 660 is configured to display a video call rejection configuration setting interface and a webpage for registering the video call rejection configuration. The display unit 660 also can display the video data input through the camera unit 650 and received from a counterpart mobile terminal. The display unit 660 displays the video signals and color information supplied by the control unit 680. The display unit 660 also displays various announcement messages generated while the mobile terminal operates.

Particularly in an exemplary embodiment of the present invention, the display unit 660 is configured to switch on in the video call mode for displaying the visual images transmitted by the counterpart mobile terminal and taken by its camera simultaneously and switch off when the video call mode is switched to the voice call mode. That is the display unit 660 can be configured to switch on or off depending on the communication mode of the mobile terminal or under the command of the user.

The storage unit 670 can be implemented with at least one of Read Only Memory (ROM) and a Random Access Memory (RAM). The storage unit 670 stores diverse data generated and used in the mobile terminal. The data include application data generated while the application programs are running in the mobile terminal and received from the counterpart terminals and user data input by the user. Particularly, the data includes the control messages exchanged with the counterpart mobile terminal and user settings related to the functions supported by the mobile terminal.

In an exemplary embodiment of the present invention, the storage unit 670 also stores information related to the video call rejection configuration as shown in table 1. The video call rejection configuration related information is stored in the video call rejection configuration storage region 675. The storage unit 670 also stores the applications related to the supplementary functions including the video call rejection function. The applications related to the video call rejection function can operate as described with reference to FIGS. 1 to 5. Such applications can be stored in an application storage region (not shown) of the storage unit 670.

The storage unit 670 also can include at least one buffer for buffering the data generated while the applications are running in the mobile terminal. The storage unit 670 can be implemented with at least one of an inbuilt storage medium or an external storage medium such as a smartcard.

The control unit 680 controls the operation of the mobile terminal and signaling among the internal function blocks of the mobile terminal. The control unit 680 controls the signaling among the first and second RF units 610 and 620, the input unit 630, the audio processing unit 640, the camera unit 650, the display unit 660, and the storage unit 670.

Particularly in an exemplary embodiment of the present invention, the control unit 680 controls the functions related to the voice call mode of the mobile terminal as either the calling mobile terminal or the called mobile terminal.

In case that the mobile terminal is a called mobile terminal, the control unit 680 sets a video call rejection configuration in accordance with the user input. If an incoming video call is received, the control unit 680 determines the communication mode (video call mode or voice call mode) of the mobile terminal with reference to the video call rejection configuration. That is, when the incoming video call satisfies the conditions of the video call rejection configuration, the control unit 680 controls the mobile terminal to initiate a video call session in a voice call mode. Otherwise, when the incoming video call does not satisfy the conditions of the video call rejection configuration, the control unit 680 controls the mobile terminal to initiate a video call session in the video call mode. When the video call session is initiated in the voice call mode, the control unit 680 controls the interaction of the audio processing unit 640, the camera unit 650, and the display unit 660 to operate in the normal voice call mode. Particularly when the video call session is initiated in the voice call mode, the control unit 680 controls the operation such that the incoming video packets transmitted by the counterpart mobile terminal are processed in a background mode (or discarded) rather than in foreground processing mode.

In case that the mobile terminal is a calling mobile terminal, the control unit 680 controls the mobile terminal to transmit a video call establishment request message to a called terminal in response to a user input. At this time, the control unit 680 controls the operation such that the internal function blocks of the audio processing unit 640, the camera unit 650, and the display unit 660 operate with the configurations for the normal video call mode. If a video call rejection message is received from the called mobile terminal in response to the video call establishment request message, the control unit 680 can controls the operation of the terminal such that the mobile terminal switches the video call mode to the voice call mode. The terminal then proceeds with the video call establishment process in the voice call mode according to a preset configuration or a user input. When the communication mode is switched from the video call mode to the voice call mode, the control unit 680 controls the operation of the audio processing unit 640, the camera unit 650, and the display unit 660 to operate with the configurations for the normal voice call mode.

As aforementioned, the control unit 680 can control the operation of the terminal such that the video call session is established in the voice call mode over the 3G network without switching to a 2G network.

The control unit 680 can control the operations of the mobile terminal as either the called mobile terminal or the calling mobile terminal as described with reference to FIGS. 1 to 5. In an exemplary embodiment of the present invention, the control operations of the control unit 680 can be implemented in software operable in a processing unit (e.g. CPU, DSP) or in hardware, such as ASIC or FPGA.

Although depicted schematically with the internal function blocks related to the communication mode switching in FIG. 6, the present invention is not limited to the configuration of the mobile terminal of FIG. 6.

For instance, the mobile terminal can further include at least one of a digital broadcast unit, a short range communication unit, an Internet access unit, and so forth. Also, it is obvious to those skilled in the art that each of the internal function blocks of the mobile terminal can be removed or replaced with an equivalent device.

As described above, the communication mode switching method and apparatus of the present invention enables a mobile terminal to respond in a voice call mode when an incoming voice call satisfying the conditions of a video call rejection configuration set by the user is received, thereby protecting personal privacy without making the caller feel uncomfortable.

Also, the communication mode switching method and apparatus of the present invention allows the user to set the duration for which the incoming video calls are responded in voice call mode, thereby protecting personal privacy from being exposed unintentionally and improving utilization convenience.

Also, the communication mode switching method and apparatus of the present invention enable a mobile terminal to establish a video call session in a voice call mode in response to an incoming video call request received in a video call rejection time period set by the user and notify the user of the voice call connection, whereby the user can receive the incoming video cal without exposing his/her private situation.

Also, the communication mode switching method and apparatus of the present invention allows the user to receive an incoming video call in voice call mode, whereby it is possible to protect the private conversation with the caller from being exposed to the people around, resulting in improvement of personal privacy protection.

The above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. A video call establishment method between mobile terminals, comprising:
requesting, at a calling mobile terminal, a video call connection to a called mobile terminal;
determining, at the called mobile terminal, whether the video call connection satisfies a video call rejection configuration;
responding, when the video call connection satisfies the video call rejection configuration, to the calling mobile terminal in a voice call mode; and
establishing a video call connection in voice call mode between the calling mobile terminal operating in video call mode and the called mobile terminal operating in voice call mode.

2. The video call establishment method of claim 1, further comprising:
receiving, at the called mobile terminal, video and voice packets transmitted by the calling mobile terminal; and
processing the video packets in a background mode and the voice packets in a foreground mode to output only voice data carried by the voice packets.

3. The video call establishment method of claim 1, further comprising:
transmitting, when the video call connection satisfies the video call rejection configuration, a communication mode switching notification message from the called mobile terminal to the calling mobile terminal; and
receiving, at the called mobile terminal, a response message in response to the communication mode switching notification message from the calling mobile terminal.

4. The video call establishment method of claim 3, when the communication mode switching notification message is received, further comprising one of:
retaining the video call connection in the video call mode and switching the video call mode to the voice call mode.

5. The video call establishment method of claim 1, further comprising registering the video call rejection configuration according to a user request, the video call rejection configuration being time information for rejecting video call and comprising enable/disable status and application time (date/time/expiry).

6. The video call establishment method of claim 1, wherein establishing a video call connection in voice call mode comprises establishing a video communication channel over a 3^{rd} Generation (3G) communication network in voice call mode rather than switching to a 2 G communication network.

7. A video call establishment method between mobile terminals, comprising:
requesting, at a calling mobile terminal, a video call connection to a called mobile terminal via a mobile communication network;
determining, at the mobile communication network, whether the video call connection satisfies a video call rejection configuration of the called mobile terminal;
sending, when the video call connection satisfies the video call rejection configuration, the calling mobile terminal and the called mobile terminal a notification message informing the calling mobile terminal and the called terminal that a video call connection is initiated and available in voice call mode; and
establishing a video call connection in voice call mode between the calling mobile terminal and the called mobile terminal.

8. The video call establishment method of claim 7, wherein establishing a video call connection comprises:
configuring, at the called mobile terminal, a voice call mode upon receipt of the notification message;
establishing the video call connection in voice call mode with the calling mobile terminal operating in video call mode; and
processing incoming video packets in a background mode and incoming voice packets in a foreground mode to output only voice data.

9. The video call establishment of claim 7, wherein establishing a video call connection comprises:
configuring, at the calling mobile terminal, the voice call mode upon receipt of the notification message according to a user input;
transmitting a mode switching notification message from the calling mobile terminal to the called mobile terminal;
configuring, at the called mobile terminal, the voice call mode upon receipt of the mode switching notification message; and
establishing the video call connection between the calling mobile terminal and the called mobile terminal operating in voice call mode.

10. The video call establishment method of claim 7, wherein establishing a video call connection comprises one of establishing the video call connection in video call mode and switching the video call mode to the voice call mode.

11. The video call establishment method of claim 7, further comprising registering the video call rejection configuration with the mobile communication network, the video call rejection configuration being time information for rejecting video call and comprising an enable/disable status and application time (date/time/expiry).

12. The video call establishment of claim 7, wherein establishing a video call connection in voice call mode comprises establishing a video communication channel over a 3^{rd} Generation (3G) communication network in voice call mode rather than switching to a 2 G communication network.

13. A communication mode control method for a mobile terminal, comprising:
determining, when a video call connection is requested by a calling mobile terminal, whether information regarding the video call is requested satisfies conditions of a video call rejection configuration of a called mobile terminal;
configuring, when the information satisfies the conditions of the video call rejection configuration, the called mobile terminal into a voice call mode;
transmitting a communication mode switching notification message to the calling mobile terminal;
establishing, when a voice call mode response message is received from the calling mobile terminal, a video call connection in voice call mode with the calling mobile terminal operating in voice call mode; and
establishing, when a video call mode response message is received from the calling mobile terminal, a video call connection in voice call mode with the calling mobile terminal operating in video call mode.

14. The communication mode control method of claim 13, wherein the voice call mode is a communication mode in which the mobile terminal operates as in a normal voice call mode regardless of the communication mode of the calling mobile terminal.

15. The communication mode control method of claim 13, further comprising:
receiving a communication mode switching response message in response to the communication mode switching notification message; and
determining whether the communication mode switching response message is the voice call mode response message for a voice call mode connection or the video call mode response message for proceeding with the video call connection.

16. The communication mode control method of claim 13, further comprising processing video packets transmitted by the calling mobile terminal in a background mode after establishing a video call connection in voice call mode with the calling mobile terminal operating in video call mode.

17. The communication mode control method of claim 16, wherein establishing a video call connection in voice call mode with the calling mobile terminal operating in video call mode comprises establishing a video communication channel over a 3^{rd} Generation (3G) communication network in voice call mode rather than switching to a 2 G communication network.

18. A communication mode control method for a mobile terminal, comprising:
transmitting, at a calling mobile terminal, a video call connection request message to a called mobile terminal;
receiving a response message in response to the video call connection request message;
checking, when the response message is a video call rejection message, a communication mode of the calling mobile terminal;
establishing, when the communication mode of the calling mobile terminal is a video call mode, a video call connection in video call mode;
switching, when the communication mode of the calling mobile terminal is a voice call mode, the video call mode to the voice call mode; and
establishing a video call connection in voice call mode with the called mobile terminal operating in voice call mode.

19. The communication mode control method of claim 18, wherein the response message is transmitted by the called mobile terminal or a mobile communication network, and the response message is one of the video call rejection message and a video call accept message.

20. The communication mode control method of claim 19, further comprising determining, when the response message is the video call rejection message, whether a user wants to proceed with the video call connection or switch the video call mode to the voice call mode.

21. The communication mode control method of claim 19, further comprising transmitting, when the communication mode is determined, a communication mode notification message to the called mobile terminal.

22. The communication mode control method of claim 18, further comprising:
blocking, when the video call connection is established in voice call mode with the called mobile terminal, generation of video packets; and
generating voice packets and transmitting the voice packets to the called mobile terminal.

23. The communication mode control method of claim 22, wherein establishing a video call connection in voice call mode with the called mobile terminal operating in voice call mode comprises establishing a video communication channel over a 3^{rd} Generation (3G) communication network in voice call mode rather than switching to a 2 G communication network.

24. A mobile terminal comprising:
a camera unit which captures visual image input through a lens and converts the visual image into video data in video call mode;
a display unit which displays images captured by the camera unit and received from a counterpart terminal simultaneously in the video call mode;
a storage unit which stores a video call rejection configuration; and
a control unit which controls a video call connection in voice call mode over a 3^{rd} Generation (3G) network without switching to a 2G network, the control unit including a processor for;
receiving information regarding a status of the counterpart terminal; and
establishing a configuration based on the status of the counterpart terminal.

25. The mobile terminal of claim 24, further comprising:
a first radio frequency unit which establishes a communication channel with the counterpart terminal via the 3G network for voice, video, and data communications; and
a second radio frequency unit which establishes a communication channel with the counterpart terminal via the 2G network for voice and data communications.

26. The mobile terminal of claim 24, wherein the control unit switches on the camera unit and the display unit in the video call mode and switches off the camera unit and the display unit in the voice call mode.

27. The mobile terminal of claim 26, wherein the control unit determines, when the mobile terminal is a called mobile terminal and receives an incoming call, whether the incoming video call satisfies the video call rejection configuration and performs an action corresponding to a result of the determination.

28. The mobile terminal of claim 27, wherein the control unit processes incoming video packets in a background mode when the mobile terminal operates in voice call mode.

29. The mobile terminal of claim 26, wherein the control unit controls, when the mobile terminal is a calling mobile terminal and receives a video call rejection configuration in response to a video call connection request, to process the video call connection in video call mode or switch the video call mode to the voice call mode.

30. The mobile terminal of claim 26, wherein the video call rejection configuration is time information and an enable/disable status and application time (date/time/expiry).

31. A mobile terminal including:
a processor in communication with a memory, the memory storing code which when accessed by the processor causes the processor to:
transmit a request message to establish a video call mode;
receive a notification message in response to the request message;
switching to a voice call mode in response to the notification message, wherein at least audio data is transmitted.
